(19) United States
(12) Patent Application Publication
(10) Pub. No.: US 2016/0042010 A1
(43) Pub. Date: Feb. 11, 2016

(54) Systems and Methods of Facilities Location

(71) Applicant: COX COMMUNICATIONS, INC., Atlanta, GA (US)

(72) Inventor: John Robert Schuler, Sandy Springs, GA (US)

(73) Assignee: COX COMMUNICATIONS, INC., Atlanta, GA (US)

(21) Appl. No.: 14/456,802

(22) Filed: Aug. 11, 2014

(51) Int. Cl. G06F 17/30; G06Q 50/06

(52) U.S. Cl. CPC G06F 17/30241; G06F 17/30554; G06Q 50/06

(57) ABSTRACT

Disclosed herein are systems and methods of facilities location, in which a customer activates an application and that application determines, from the GPS device, a location and the locations of the various cables or equipment buried in their yard. The customer may mark the service location using the supplied information on the device application. In an example embodiment, if the customer has further questions, he may call into the center, for example, by pressing a voice button, to talk to a person regarding the questions. In this embodiment, a two way communication is enabled to provide the customer with additional assistance in locating the facilities.

### TECHNICAL FIELD

The present disclosure is generally related to utilities and, more particularly, is related to facilities location.

### BACKGROUND

Homeowners often make risky assumptions about whether or not they should get their utility lines marked, but every digging job requires a call to the regional One Call Center that is a Co-Op by local utilities providers. Even small projects like planting trees and shrubs or placing a fence may require a utility location to avoid disaster for the utility and home owner. The depth of utility lines varies and there may be multiple utility lines in a common area such as water, electric, cable, telephone, gas, and security. Digging without calling the One Call Center can disrupt service to an entire neighborhood or larger group of customers, harm the digger and those nearby, and potentially result in fines and repair costs for all involved. Customers can call 811 before every digging job results in underground utility lines marked for free and helps prevent undesired consequences; yet, at times, this is not done due to inconvenience and other barriers.

Federally-mandated national “Call Before You Dig” number, 8-1-1 was created to help protect homeowners from unintentionally hitting underground utility lines while working on digging projects. This program is in place around the entire USA and serves a key public function as well as private function to protect people, property, and service. People digging often make risky assumptions about whether or not they should get their utility lines marked due to concerns about project delays, costs and previous calls about other projects. Examples can be found in the news in which a gas line was not marked and it resulted in death and property destruction. These issues may be avoided by using the proper procedures outlined in the Utility Location Domain. These assumptions can be life-threatening. In March 2005, the United States Federal Communications Commission (FCC) made 8-1-1 the universal number for the 71 regional services that coordinate location services for underground public utilities in the U.S. Before that time, each of these “call before you dig” services had its own 800 number, and the FCC and others wanted to make it as easy as possible for everyone planning an excavation to call first. This safety measure not only prevents damage that interrupts telecommunications, but also the cutting of electricity, water mains, and natural gas pipes. Establishment of an abbreviated dialing number for this purpose was required by the Pipeline Safety Improvement Act of 2002.

A homeowner can call 8-1-1 from anywhere in the country a few days prior to digging, and the call will be routed to the local One Call Center. The customer tells the operator where he is planning to dig, what type of work he will be doing, and the affected local utilities companies will be notified about the intent to dig. In a few days, a locator is sent to mark the approximate location of the underground lines, pipes, and cables, so the customer knows what is below and he can dig safely. This process has not evolved since inception and allows for error due to the exchange of verbal information and the lack of technology engaged and utilized. With the advent of smart phones and applications, better and non-intuitive solutions exist.

However, not every customer is willing to wait and a faster method of notifying customers is warranted. So, there are heretofore unaddressed needs with previous utility location solutions.

### SUMMARY

Example embodiments of the present disclosure provide systems of facilities location. Briefly described, in architecture, one example embodiment of the system, among others, can be implemented as follows: a computer server configured to collect facilities location data from a plurality of sources and store the data in a storage device; a boundary generation system configured to receive a facilities location request for a particular location and to generate a set of boundaries that contain facilities for that particular location; and an application server configured to send the set of boundaries for the particular location.

Embodiments of the present disclosure can also be viewed as providing methods for facilities location. In this regard, one embodiment of such a method, among others, can be broadly summarized by the following steps: receiving a facilities location request, the request comprising location information; accessing a database of facility location data related to the location information; creating a geofence using the facility location data; and sending the created geofence.

### BRIEF DESCRIPTION OF THE DRAWINGS

FIG. 1 is a system diagram of an example embodiment of a system of facilities location.

FIG. 2 is an overhead view of an example embodiment of a premises for the location of facilities.

FIG. 3 is an overhead view of a premises with the facilities located.

FIG. 4 is a flow diagram of an example embodiment of a method of facilities location.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

From time to time, a customer's service is interrupted due to a poorly marked service drop given construction and other activity which occurs at a customer location. Due to this, costs, dispatches and resources are used to repair the issue while the customer experiences an outage condition. This happens on a frequent and regular basis for telecommunication service provider customers, such as cable television, internet, and telephone customers, among others that rely on a physical connection between a network and home or work location. These result in economic and social costs that are folded back into the rate model or customer cost model and increase the costs for all customers. In addition, with the remote sensoring and possibility of serious medical, security, and life conditions, the uninterrupted continuation of service to a location, either residential or business, has become expected given the adverse consequence of a loss of the service.

Example embodiments of the disclosed systems and methods of facilities location deal with premises with underground services. The location service requests may occur several times daily for a particular service provider. Additionally, the services location may be repeated at the same location over and over and, thus, ‘persistence of information’ may be achieved without incurring costs again and again. When information is collected, it may be stored to be re-utilized and data sources (not limited to utilities) may be updated when available. As an example, when a telecommunications company places a new fiber conduit down a street, the data base would be updated with this information. When services are required to be located as a preventative measure, the location costs time, effort, and fuel and is not a 100% accurate. The location is subject to delay and coordination of activity and is currently a human expense. The goal is to enable a customer to use the GPS on the device and match up with a series of maps to replace the human interaction of a location service in a more accurate and timely manner. Not limited to this concept, a locating company can use this technology business to assist in the location of the utilities as well.

Example embodiments of the systems and methods of facilities location disclosed herein improve and achieve the goal of less dispatches and reduced damage to utilities properties. In an example embodiment, Android and IOS applications may be implemented to create a self-locate capability into the customer hands in a real time basis.

In example embodiments, customers may call into a contact center to locate services that are sponsored by a company that does work in a specific area such as gas, cable, and electricity, among others and the request is dispatched to the responsible group. In an example embodiment, the customer uses a mobile device, for example, an Android or IOS device, among others with GPS capabilities. The facilities that are on the customer's location are detailed in the database. The application can outline the facilities locations to avoid damaging the customer's service or interrupting the service.

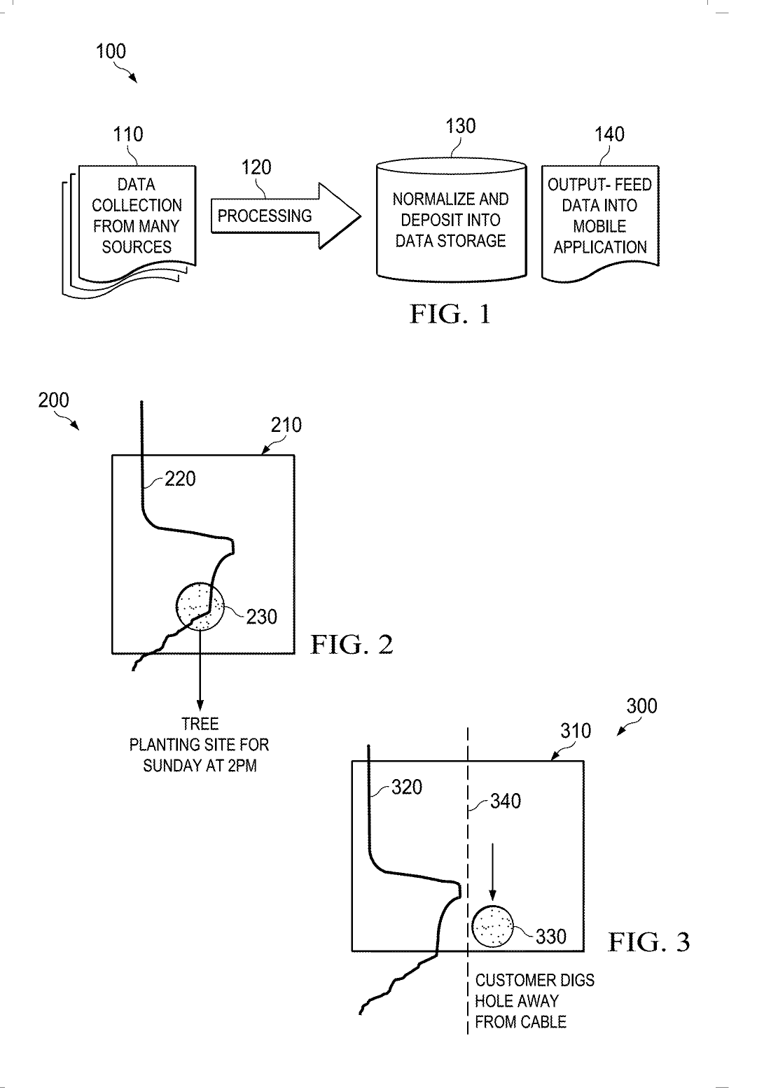

FIG. 1 provides an example embodiment of system 100 of facilities location. In block 110, data is collected from many sources. In block 120, the data is processed so that, in block 130, the data may be normalized and deposited into data storage. When a facilities location request is received, the output of the system in block 140 feeds the data to the mobile application on the device associated with the facilities location request. As the data base is expanded and more information is obtained, the unique ability of customer access in real time becomes a new and powerful tool.

In an example embodiment, the customer activates an application and that application determines, from the GPS device, a location and determines the locations of the various cables or equipment buried in their yard or in the general area. The customer may mark the service location using the supplied information on the device application. In an example embodiment, if the customer has further questions, he may call into the center, for example, by pressing a voice button, to talk to a person regarding the questions. In this embodiment, a two way communication is enabled to provide the customer with additional assistance in locating the facilities. At that time, a real time map sharing session may be initiated to allow a robust interaction and assessment of the situation.

Example embodiments of the systems and methods of facilities location disclosed herein may use GPS or other cable systems, cellular station systems, etc. to locate the premises and the location of the services on the premises. Such systems and methods would be helpful to first responders to locate facilities in emergency situations as well. In an example embodiment, a metal detector or fluid detector may be added to a mobile device to further aid in the location of the facilities.

Example embodiments of the systems and methods disclosed herein may gather information on the service locations from one or more of the following collection points: the customer, the installer, property records, the municipality of the premises, contractors, utility records, maps, drawings, physical observations, and aerial views, among others.

Example embodiments of the systems and methods of facilities location disclosed herein may include the creation of geographic information system (GIS) boundaries for known facilities. These GIS boundaries may be integrated into an Android or IOS Application or a web-based application, as non-limiting examples, allowing access to facility information to the customer. One example may include an overlay with Google Maps to provide an interactive mash up to determine where facilities are located within a location in relation to major structures, streets, and other physical aspects of the location.

In example embodiments, the system stores and maintains records. The system may be integrated into core systems to receive location efforts, such as an early warning system, for example. When the customer uses the application to locate facilities, the system may create a GeoFence around the facilities, which allows for customer self-service and real time information. Geofencing is a feature in a software program that uses the global positioning system (GPS) or radio frequency identification (RFID) to define geographical boundaries. A geofence is a virtual barrier. Geofence programs allow an administrator to set up triggers so when a device crosses a geofence and enters (or exits) the boundaries defined by the administrator, an SMS or email alert may be sent. Alternatively, a physical marker may be placed.

Many geofencing applications incorporate Google Earth, allowing administrators to define boundaries on top of a satellite view of a specific geographical area. Other applications define boundaries by longitude and latitude or through user-created and Web-based maps. Geofencing has many uses including: mobile device management, fleet management, human resource management, compliance management, marketing, and asset management. With mobile device management, for example, when a hospital tablet PC leaves the hospital grounds, an administrator receives notification so the device can be disabled. In a similar fashion, construction equipment may be configured to be disabled when it passes across a geofence boundary. This is an additional safety mechanism that may reduce mistakes due to operator performance and may remove liability and damage concerns for the company providing the service.

With example embodiments of the systems and methods of facilities location disclosed herein, customers, contractors, or anyone may locate facilities safely and reliably using GPS technology and a data base, for example. The system may use application mobile developer and GPS handset capabilities to geomark facilities and use geofencing to allow a customer the ability to discover underground facilities.

In an example embodiment, the facilities location is marked in the records with a GPS system when installed. Then the location may be verified with physical location to further reduce drop cuts. The technician may receive the drop GPS coordinates with a PC/phone with the lot dimensions from the country record office with a real time integration of activating the ‘record utility’ and is prompted throughout the process to outline type and location and allow for verification. In this example embodiment, the plow has GPS coordinates automatically programmed within the plow system. A GPS marked boundary, sometimes called GIS Fencing, may be implemented around the drop zone. When the plow gets too close the boundary, perhaps it automatically shuts down, starts making a beeping noise and thus removes the defect. This allows ‘mistake proofing’ which is a key outcome of removing special or attributable cause and makes the process double checking itself while relieving the complexity for the person doing the process.

FIG. 2 provides an example implementation of a use of the systems and methods disclosed herein with overhead view 200 of a premises in which a customer would like to plant tree 230 in premises 210. In this particular scenario, the customer is doing some gardening on Sunday afternoon. However, unbeknownst to the customer, services line 220 runs through the middle of tree planting site 230. Since it's a Sunday, no customer service representatives are available to consult regarding the facilities locations. The application including the automation allows for location service outside of traditional working hours when most home projects are being conducted. This is an expansion of available resources that results in reduced social and economic costs.

With the example embodiments of the systems and methods enclosed herein, the customer runs the app on his GPS and determines that the facilities line runs through his proposed planting site. FIG. 3 provides an example implementation of a use of the systems and methods disclosed herein with overhead view 300 of premises 310 in which a customer has determined the location of the facilities. Once the customer has determined that facilities 320 run through a particular area, geofence 340 is determined and new planting site 330 is devised on the appropriate side of geofence 340. This has prevented cuts lines on a Sunday afternoon with no technician involvement from the service provider. Additionally, the information may be used over and over again with little to no future costs.

The current method of services location uses a cable location or like service. The disclosed systems and methods allow a customer to use a GPS application on a mobile device and geofencing to locate the drop locations by accessing the data base at the service provider. In an example embodiment, the application allows a customer to locate the drop with a reliable interaction and thus avoiding a technician or other service from locating the drop. In an example embodiment. Drops are marked by a technician at installation using GPS.

Example embodiments of the disclosed systems and methods of facilities location receive cable coordinates that any customer can download to a mobile device. All available service coordinates are offered to lessen the potential of cut drops or damaged facilities by using Geofencing. A customer may use a ‘self-service’ function to locate drops and underground facilities. Geofencing or geolocating may be implemented to ‘mark off’ areas within public or private property with utility services. A device may be implemented with a notification system such that, for example, a warning light blinks on a device, such as an Android device, for example, when an underground service is near.

In an example embodiment, a message, such as non-limiting examples of an SMS, email, or VoIP phone call, is placed to the facility provider from the application with the coordinates of the activity as a preventative measure when a GeoFence is broken. The service provider may then contact the customer and offer assistance.

In an example implementation, a customer may call into a contact center to locate services that are sponsored by a company that does work in a specific area such as gas, cable, electricity. This request may be dispatched to the group so that the facilities location may be marked using a detector. The customer may activate an application and that application determines, from the GPS module in the device, a location and the various cable or equipment buried in the premises for the customer to mark. If the customer has further questions, he may call into the service center using a voice button, for example and talk to a person regarding the questions.

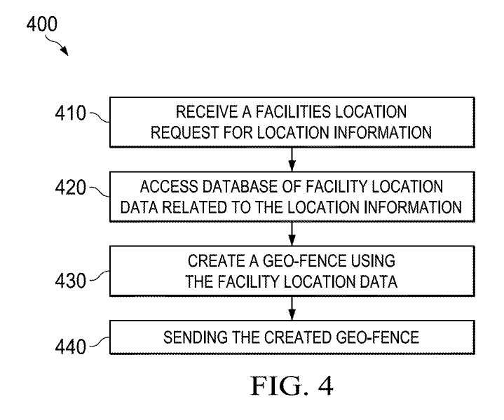

FIG. 4 provides flow chart 400 of an example embodiment of a method of facilities location. In block 410, a facilities location request for location information is received. In block 420, a database of facility location data related to the location information is accessed. In block 430, a geofence is creates using the facility location data. In block 440, the created geofence is sent.

The flow chart of FIG. 4 shows the architecture, functionality, and operation of a possible implementation of the facilities location software. In this regard, each block represents a module, segment, or portion of code, which comprises one or more executable instructions for implementing the specified logical function(s). It should also be noted that in some alternative implementations, the functions noted in the blocks may occur out of the order noted in FIG. 4. For example, two blocks shown in succession in FIG. 4 may in fact be executed substantially concurrently, or the blocks may sometimes be executed in the reverse order, depending upon the functionality involved. Any process descriptions or blocks in flow charts should be understood as representing modules, segments, or portions of code which include one or more executable instructions for implementing specific logical functions or steps in the process, and alternate implementations are included within the scope of the example embodiments in which functions may be executed out of order from that shown or discussed, including substantially concurrently or in reverse order, depending on the functionality involved. In addition, the process descriptions or blocks in flow charts should be understood as representing decisions made by a hardware structure such as a state machine.

The logic of the example embodiment(s) can be implemented in hardware, software, firmware, or a combination thereof. In example embodiments, the logic is implemented in software or firmware that is stored in a memory and that is executed by a suitable instruction execution system. If implemented in hardware, as in an alternative embodiment, the logic can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc. In addition, the scope of the present disclosure includes embodying the functionality of the example embodiments disclosed herein in logic embodied in hardware or software-configured mediums.

Software embodiments, which comprise an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, or communicate the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a nonexhaustive list) of the computer-readable medium would include the following: a portable computer diskette (magnetic), a random access memory (RAM) (electronic), a read-only memory (ROM) (electronic), an erasable programmable read-only memory (EPROM or Flash memory) (electronic), and a portable compact disc read-only memory (CDROM) (optical). In addition, the scope of the present disclosure includes embodying the functionality of the example embodiments of the present disclosure in logic embodied in hardware or software-configured mediums.

Although the present invention has been described in detail, it should be understood that various changes, substitutions and alterations can be made thereto without departing from the spirit and scope of the invention as defined by the appended claims.

Therefore, at least the following is claimed:

1. A method comprising:
receiving a facilities location request, the request comprising location information;
accessing a database of facility location data related to the location information; creating a geofence using the facility location data; and
sending the created geofence.

2. The method of claim 1, wherein the database is populated using at least one of customer data; installation data; municipality data; contractor data; and location data.

3. The method of claim 1, further comprising creating geographic information system (GIS) boundaries for known facilities.

4. The method of claim 1, wherein the facilities location request is received through an ANDROID or IOS mobile application or a web-based application.

5. The method of claim 1, wherein the facilities location comprises at least one of television cable location, plain old telephone service wire location, gas line location, electrical power line location, water line location, and sprinkler system pipe location.

6. The method of claim 1, wherein the geofence comprises global positioning system (GPS) coordinates referenced to premises dimensions supplied by a property records entity.

7. A system, comprising:
a computer server configured to collect facilities location data from a plurality of sources and store the data in a storage device;
a boundary generation system configured to receive a facilities location request for a particular location and to generate a set of boundaries that contain facilities for that particular location; and
an application server configured to send the set of boundaries for the particular location.

8. The system of claim 7, wherein the computer is configured to collect facilities location data from at least one of customer data; installation data; municipality data; contractor data; and location data.

9. The system of claim 7, wherein the computer is configured to collect facilities location data from at least one of utility records, maps, drawings, physical observations, and aerial views.

10. The system of claim 7, wherein the boundary generation system creates geographic information system (GIS) boundaries for known facilities.

11. The system of claim 7, wherein the set of boundaries is sent to a device running at least one of an ANDROID or an IOS mobile application or a web-based application.

12. The system of claim 7, wherein the facilities location data comprises at least one of television cable location, plain old telephone service wire location, gas line location, electrical power line location, water line location, and sprinkler system pipe location.

13. The system of claim 7, wherein the set of boundaries defines a geofence around the facilities.

14. The system of claim 12, wherein the geofence comprises global positioning system (GPS) coordinates referenced to premises dimensions supplied by a property records entity.

15. A non-transitory computer readable medium comprising software, the software comprising instructions for:
receiving a facilities location request, the request comprising location information;
accessing a database of facility location data related to the location information; creating a geofence using the facility location data; and
sending the created geofence.

16. The computer readable medium of claim 15, further comprising instructions for populating the database using at least one of customer data; installation data; municipality data; contractor data; and location data.

17. The computer readable medium of claim 15, further comprising instructions for creating geographic information system (GIS) boundaries for known facilities.

18. The computer readable medium of claim 15, wherein the facilities location request is received through an ANDROID or IOS mobile application or a web-based application.

19. The computer readable medium of claim 15, wherein the facilities location comprises at least one of television cable location, plain old telephone service wire location, gas line location, electrical power line location, water line location, and sprinkler system pipe location.

20. The computer readable medium of claim 15, wherein the geofence comprises global positioning system (GPS) coordinates referenced to premises dimensions supplied by a property records entity.
